(19) United States
(12) Patent Application Publication
(10) Pub. No.: US 2026/0112187 A1
(43) Pub. Date: Apr. 23, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YUUICHI NITTO, Kanagawa (JP)

(21) Appl. No.: 19/362,582

(22) Filed: Oct. 20, 2025

(30) Foreign Application Priority Data
Oct. 22, 2024 (JP) 2024-186062

(51) Int. Cl. G06V 30/12; G06V 30/19; G06V 30/42

(52) U.S. Cl. CPC G06V 30/12; G06V 30/19093; G06V 30/42

(57) ABSTRACT

An information processing apparatus recognizes multiple character strings in a scanned image of a form on which a piece of identification information for identifying a form issuer is written by performing character recognition processing on the scanned image, and inquires of an external system, in which multiple pieces of identification information are registered, whether the character string recognized from the piece of identification information among the recognized multiple character strings is registered in the external system. In the case where the character string is registered, the information processing apparatus displays information that the character string is registered. In the case where the character string is not registered, the information processing apparatus displays information that the character string is not registered and displays a similar character string similar to one of the multiple character strings as a correction candidate for the one character string.

### BACKGROUND

### Field of the Technology

The present disclosure relates to a graphical user interface (GUI) for computerizing and using business forms.

### Description of the Related Art

In recent years, there has been a system in which information extracted based on OCR results of scanned images of business forms (hereinafter simply referred to as forms) is checked and corrected if necessary, and the OCR results checked and corrected are stored in a database and used for business processes.

Regarding a technology for using OCR results, Japanese Patent Laid- Open No. 2024-55745 discloses a technology for querying registrant information to find an identification number of a form issuer and an issue date of a form, which are extracted based on an OCR result of a scanned image of the form on which the identification number registered in the registrant information is written.

### SUMMARY

An information processing apparatus according to an aspect of the technology of the present disclosure includes: at least one memory that stores instructions; and at least one processor that executes the instructions to: obtain a scanned image of a form on which a piece of identification information for identifying a form issuer is written; recognize a plurality of character strings in the scanned image by performing character recognition processing on the scanned image; inquire of an external system, in which a plurality of pieces of identification information are registered, whether a character string recognized from the piece of identification information among the plurality of character strings recognized is registered in the external system; display information indicating that the character string is registered in the external system in a case where the character string recognized from the piece of identification information is registered in the external system; display information indicating that the character string is not registered in the external system in a case where the character string recognized from the piece of identification information is not registered in the external system; and display a similar character string similar to one character string among the plurality of character strings as a correction candidate for the one character string.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an overview of an information processing system.

FIG. 2 is a diagram illustrating a hardware configuration example of an information processing apparatus.

FIG. 3 is a diagram illustrating a functional configuration example of the information processing apparatus.

FIG. 4 is a diagram illustrating a sequence in the information processing system;

FIGS. 5A-5C are tables presenting examples of data to be processed in the information processing system.

FIG. 6 is a diagram illustrating a UI screen example.

### DESCRIPTION OF THE EMBODIMENTS

Hereinafter, embodiments for carrying out the technology of the present disclosure will be described in detail with reference to the attached drawings. It should be noted that the following embodiments are not intended to limit the technology of the present disclosure according to claims. All of combined features described in the embodiments are not necessarily essential for the solution of the technology of the present disclosure, and any two or more of the features may be combined as needed. The same constituent elements will be described with the same reference signs.

### First Embodiment

### System Configuration

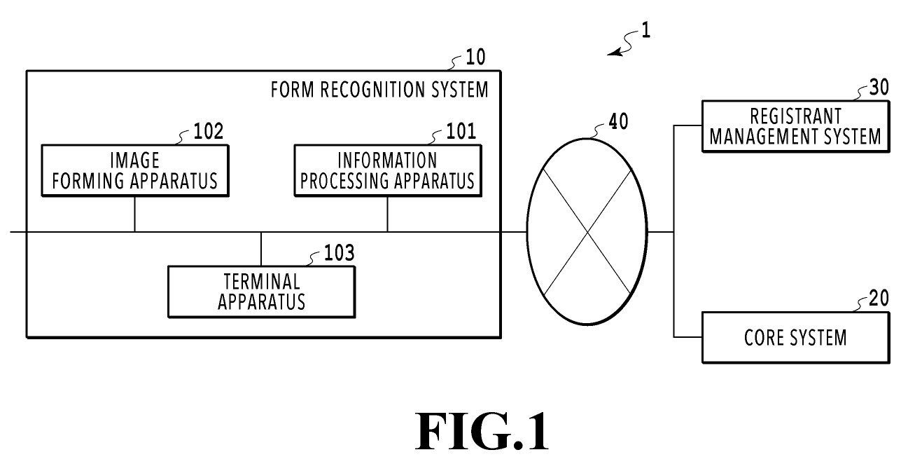

FIG. 1 is a diagram illustrating an overview of an information processing system according to the present embodiment. An information processing system 1 in the present embodiment includes a form recognition system 10, a core system 20, and a registrant management system 30, and the systems 10, 20, and 30 are connected to each other via a network 40 so that data can be transmitted and received between them. The form recognition system 10 includes an information processing apparatus 101, an image forming apparatus 102, and a terminal apparatus 103, and the apparatuses 101, 102, and 103 are connected to each other via a network so that data can be transmitted and received between them. For example, the terminal apparatus 103 is connected to the core system 20 via the network so that data can be transmitted and received between them.

The present embodiment will be described by using an invoice as an example of forms; however, the present technology can be also applied to other forms such as receipts, delivery notes, and contracts, and will have the same effect on these forms. The form recognition system 10 will be described as extracting information from a scanned image of a form obtained by scanning an invoice, the information including business operator information indicating a business operator, that is, an issuer of the invoice, invoice information indicating a billing amount, and detailed information indicating the details of the invoice.

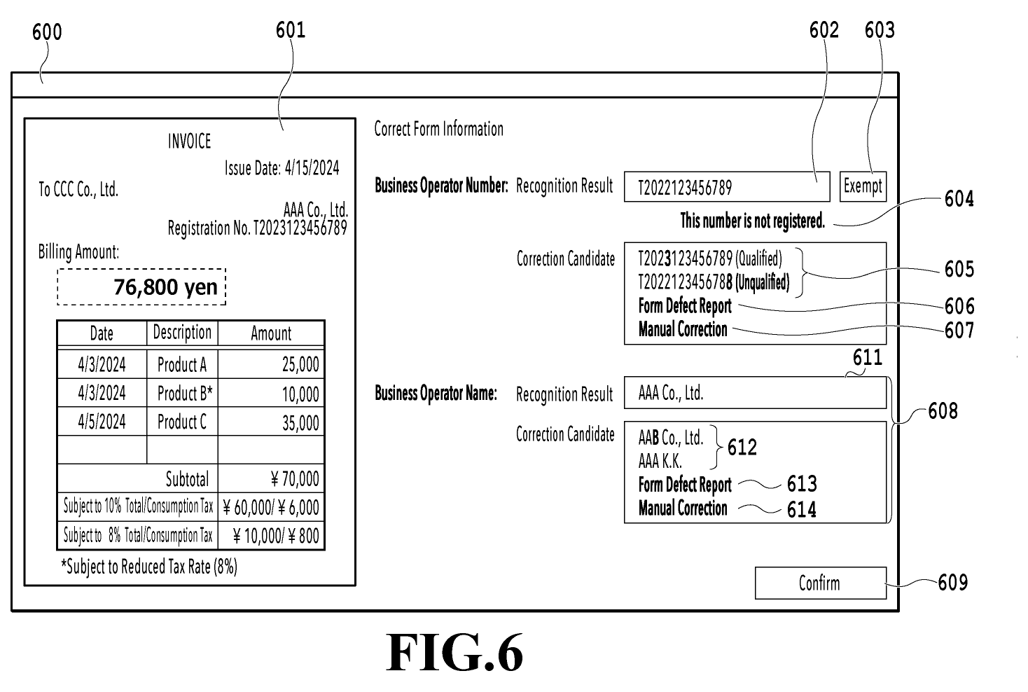

In the form recognition system 10, the information processing apparatus 101 scans a form by using a scanner function of the image forming apparatus 102, thereby obtaining image data representing the scanned image of the form. The information processing apparatus 101 may receive image data representing a scanned image of a form from the terminal apparatus 103. In the case where the information processing apparatus 101 obtains image data representing a scanned image of a form, the information processing apparatus 101 extracts items and item values included in the scanned image of the form and generates text data in which the items and the item values are associated with each other. With reference to FIG. 6 to be described later as an example, text data is generated in which a document title and "Invoice", a billing destination and "CCC Co., Ltd.", a billing amount and "76,800", an issue date and "4/15/2024", and a biller and "AAA Co., Ltd." are associated with each other. Text data is generated in which a registration number, which is a piece of identification information for identifying the form issuer and "T2023123456789", a detail and a date, and a product name and an amount are associated with each other.

The core system 20 is, for example, a system to perform specific processing using a result obtained through form recognition by the form recognition system 10. In the case where a form is an invoice, the core system 20 may be an accounting system to perform specific processing such as transferring a billing amount to a financial institution.

The registrant management system 30 is a system including an apparatus to manage the registrant information. For example, the registrant management system 30 may be a management system including a server managed by a government office in charge of registration of qualified invoice issuers in the qualified invoice system. The qualified invoice system is a system of input tax credit that was introduced to accommodate multiple tax rates. The registrant information is information specifying the address, the name, and the registration period of a qualified invoice issuer. The information on the registration period (term of validity) indicates a period calculated from information on a registration date, information on an update date, and information on an expiration date. In response to a request to obtain the registrant information received from the form recognition system 10, the registrant management system 30 transmits the registrant information to an apparatus having transmitted the request to obtain.

In the following description, a scanned image of a form and image data representing the scanned image of the form will be referred to as a form image and form image data, respectively. In addition, in the following description, processing of extracting the name of each of items (item name) included in a form image and its value (item value) as item information on this item, and converting the item name and the item value into text data while associating them with each other will be referred to as form recognition. A result of this recognition will be referred to as form information.

### Hardware Configuration of Information Processing Apparatus

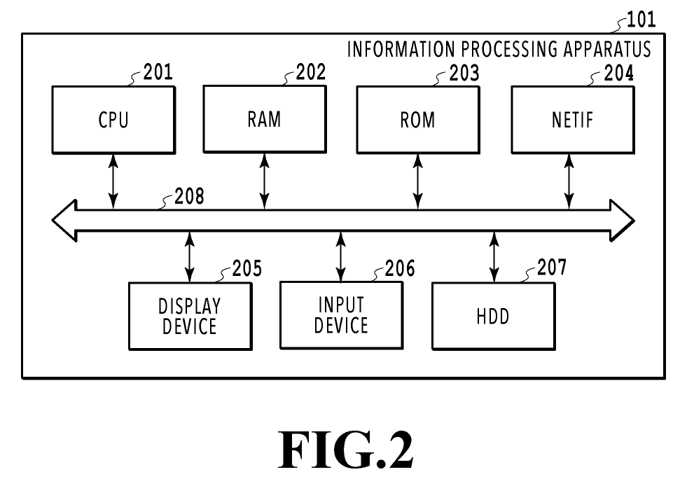

FIG. 2 is a diagram illustrating a hardware configuration example of the information processing apparatus 101. Note that hardware configurations of the image forming apparatus 102 and the terminal apparatus 103 are the same as the hardware configuration of the information processing apparatus 101 illustrated in FIG. 2.

The information processing apparatus 101 includes a CPU 201, a RAM 202, a ROM 203, a network interface 204, a display device 205, an input device 206, an HDD 207, and an input/output bus (address bus, data bus, and control bus) 208.

The CPU 201 is a central processing unit to control a computer system. Based on a control program, the CPU 201 performs calculation and processing of information and controls each piece of hardware, thereby implementing each functional configuration and processes to be described later. The RAM 202 is a random access memory and functions as a main memory of the CPU 201, that is, a work memory necessary to load an execution program and execute the program. The ROM 203 is a read only memory, and records the control program specifying operation processing procedures for the CPU 201. The ROM 203 includes a program ROM that records basic software (OS), which is a system program that controls the equipment of the computer system, and a data ROM that records information or the like necessary to operate the system. The HDD 207 to be described below may be used in place of the ROM 203. The network interface (abbreviated as NETIF) 204 controls input and output of data of images and the like transmitted and received via the network. The display device 205 is, for example, a CRT display, a liquid crystal display, or the like. The input device 206 is a device for receiving operation instructions from a user, and is, for example, a touch panel, a keyboard, a mouse, or the like. The HDD 207 is a storage apparatus and is used to store application programs and data of images and the like. The input/output bus 208 connects the units in the information processing apparatus 101 to each other and transmits information between the units.

### Functional Configurations of Information Processing Apparatus and Terminal Apparatus

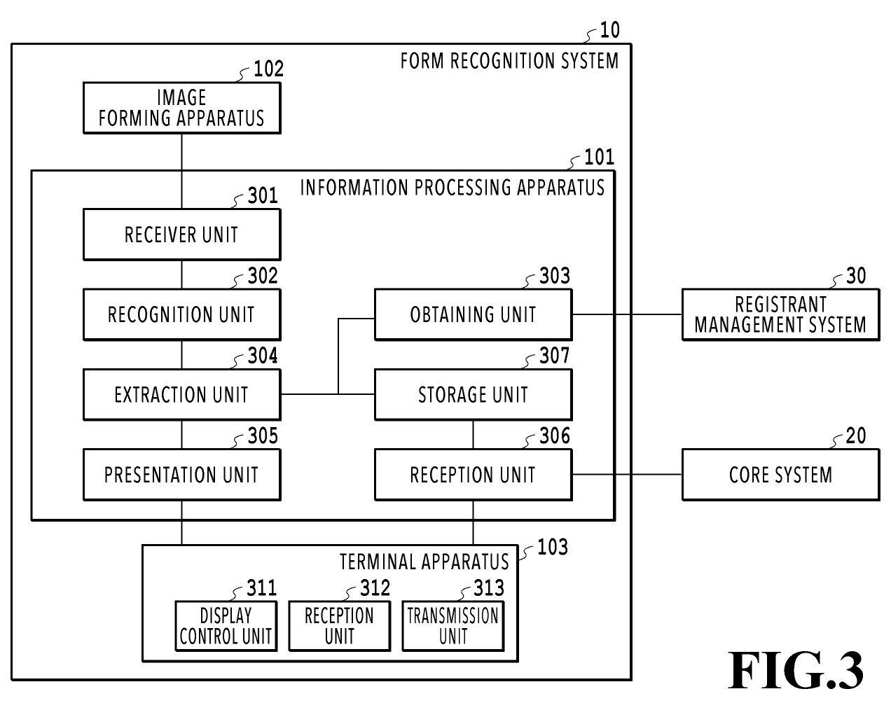

FIG. 3 is a block diagram illustrating functional configurations of the information processing apparatus 101 and the terminal apparatus 103. The information processing apparatus 101 includes a receiver unit 301, a recognition unit 302, an obtaining unit 303, an extraction unit 304, a presentation unit 305, a reception unit 306, and a storage unit 307.

The receiver unit 301 receives and obtains a form image transmitted from the image forming apparatus 102 or the terminal apparatus 103. The receiver unit 301 thus obtains the form image, and may be referred to as an image obtaining unit. The recognition unit 302 performs the form recognition of the form image received by the receiver unit 301 and outputs the form information. The recognition unit 302 extracts a character string expressing identification information based on an optical character recognition (OCR) result obtained from the form image as will be described in detail later, and therefore may be said to function as an extraction unit.

From the registrant management system 30, the obtaining unit 303 obtains the registrant information, which is registration information of the business operator as the form issuer, based on the form information recognized by the recognition unit 302. The obtaining unit 303 thus obtains the information and may be referred to as an information obtaining unit. Here, the obtaining unit 303 obtains the registrant information every time the registrant management system 30 updates the registrant information.

The extraction unit 304 extracts similar pieces of form information similar to a piece of form information recognized by the recognition unit 302, as correction candidates for the piece of form information (form recognition result), among from multiple pieces of identification information registered in the registrant information obtained by the obtaining unit 303. In the case where the storage unit 307 to be described below stores pieces of form information, the extraction unit 304 may extract, from the pieces of form information stored in the storage unit 307, similar pieces of form information similar to the piece of form information recognized by the recognition unit 302, as correction candidates for the piece of form information. As a result of the above extraction by the extraction unit 304, similar character strings similar to the character string expressing the identification information recognized by the recognition unit 302 are obtained from among the multiple pieces of identification information registered in the registrant information. The presentation unit 305 presents to the terminal apparatus 103, information necessary for the user to confirm the form information, such as correction candidates for the form information extracted by the extraction unit 304 and the form information recognized by the recognition unit 302.

The reception unit 306 receives the form information transmitted from the terminal apparatus 103, which is the form information confirmed with a user operation received on the terminal apparatus 103 among the correction candidates for the form information presented by the presentation unit 305. The storage unit 307 stores the form information received by the reception unit 306.

The terminal apparatus 103 includes a display control unit 311, a reception unit 312, and a transmission unit 313. The display control unit 311 displays, on a display device, a UI screen including the form information and the correction candidates for the form information presented by the presentation unit 305. Via the UI screen displayed by the display control unit 311, the reception unit 312 receives a user operation for confirming the form information composed of the correct character string as the form information written in the form image, from among the form information and the correction candidates for the form information. The transmission unit 313 transmits the corrected form information confirmed with the user operation received by the reception unit 312 to the reception unit 306 of the information processing apparatus 101.

### Sequence for Form Information Storage

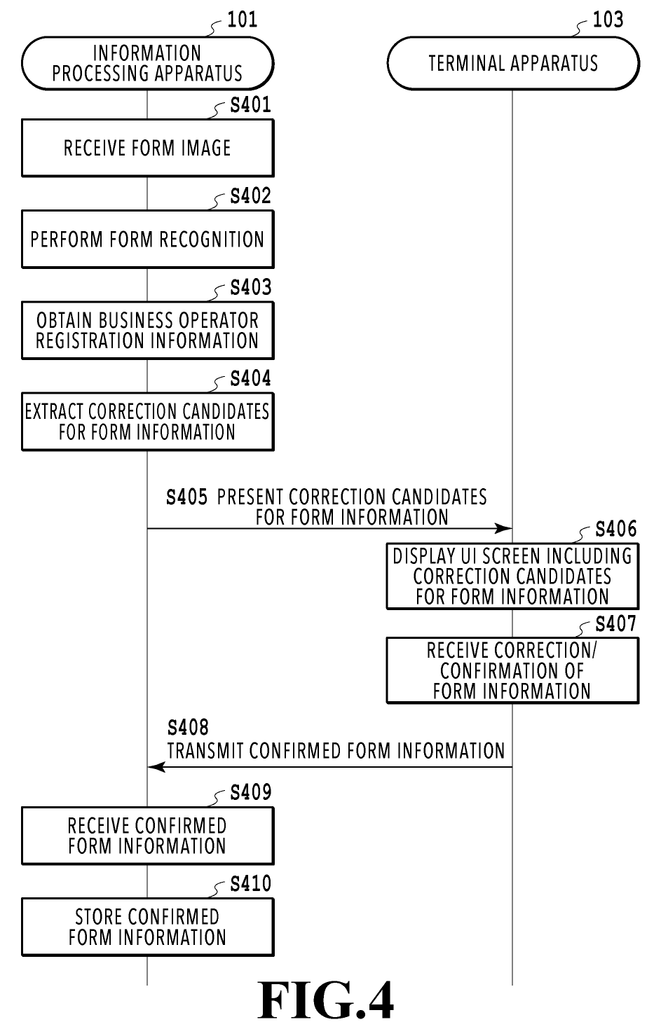

FIG. 4 is a diagram illustrating a sequence in the form recognition system 10. In description of each process, sign "S" means a step in the sequence. Hereinafter, a processing sequence in the form recognition system 10 will be described in detail with reference to FIGS. 3-6.

In S401, the receiver unit 301 receives and obtains a form image transmitted from the image forming apparatus 102 or the terminal apparatus 103.

In S402, the recognition unit 302 outputs form information, which is a form recognition result obtained through the form recognition performed on the form image received by the receiver unit 301 in S401. For example, the recognition unit 302 converts the form image received by the receiver unit 301 to text data by performing character recognition processing in a known character recognition technology. Then, the recognition unit 302 extracts specific character strings from the text data obtained by conversion, and recognizes, as the form information, specific item values of, for example, a business operator number, a business operator name, and so on, based on the positions of the extracted specific character strings and the like on the form image. The form information includes the specific item values of the business operator number, the business operator name, and so on. Regarding a form recognition method, for example, it is possible to apply a character recognition technology using template matching, in which contents in each of specific forms are defined in advance, a form type is identified based on layout characteristics of a form image, and necessary information is extracted by recognizing characters at a predetermined position in the form image. Instead, it is also possible to apply a character recognition technology using a trained model already trained through machine learning on processing of identifying a form type based on the layout characteristics of a form image and extracting necessary information by recognizing characters at a predetermined position in the form image. Although the aforementioned template matching or machine learning may be used as the form recognition method, the technology in the present disclosure is not limited to these.

In S403, the extraction unit 304 obtains the business operator registration information (registrant information) of the form issuer from the form information recognized in S402 via the obtaining unit 303. For example, the extraction unit 304 obtains the registrant information based on the business operator number of the form issuer. Specifically, by using the business operator number of the form issuer included in the recognized form information, the form recognition system 10 inquires of the registrant management system 30 about the business operator registration information. The registrant management system 30 transmits the registrant information associated with the business operator number of the form issuer to the obtaining unit 303 of the form recognition system 10. The extraction unit 304 may also obtain the registrant information including a business operator number similar to that of the form issuer included in the recognized form information. Character strings defined below may be obtained as similar character strings from the registrant management system 30 managing the registrant information in which multiple pieces of identification information expressed by character strings are registered. Specifically, similar character strings similar to the character string expressing the identification information of the form issuer extracted based on the OCR result on the form image may be obtained from among the multiple pieces of identification information registered in the registrant information. In other words, each character string of which a matching degree with the extracted character string is equal to or greater than a predetermined threshold may be obtained from the registrant information. In the case of the business operator number, a similar character string may be defined as a character string that differs by one to three characters among 14 characters expressing the identification information, and the predetermined threshold may be set to any value. In the case of the business operator name, a similar character string may be defined as a character string that differs by one character among 7 characters expressing the identification information and the predetermined threshold may be set to any value.

### Business Operator Registration Information

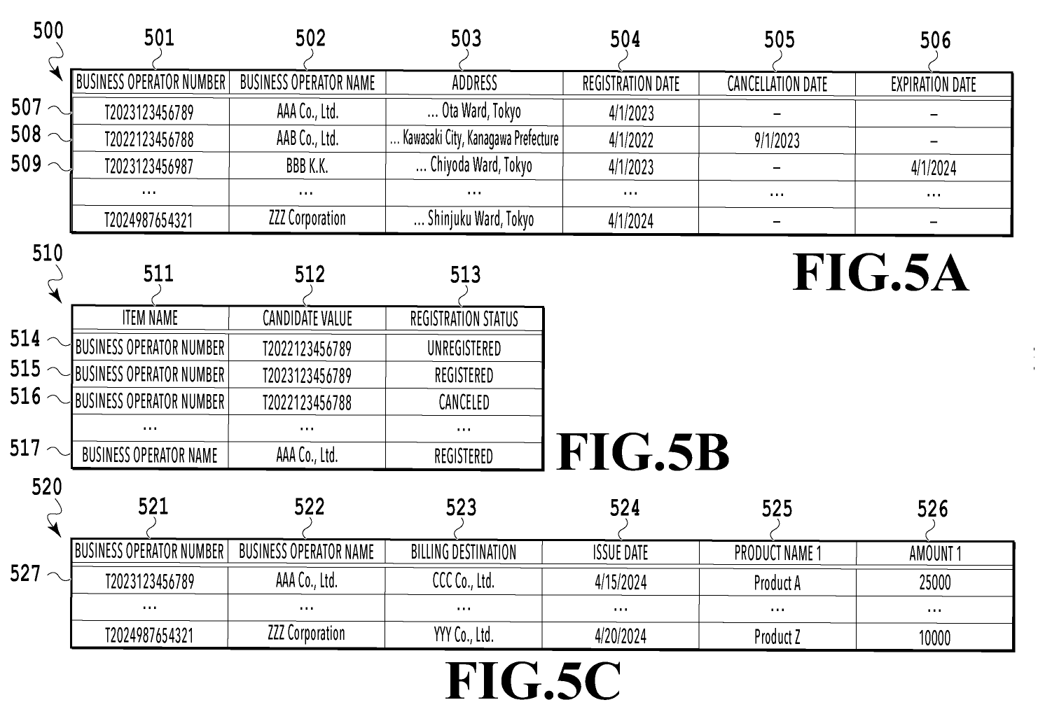

FIG. 5A is a diagram illustrating an example of business operator registration information. Business operator registration information (registrant information) 500 is presented as an example of a part of business operator registration information which is recorded and managed in the registrant management system 30, and which is obtained by the obtaining unit 303. In the business operator registration information 500, each row corresponds to one record of information indicating the business operator registration of a form issuer. For example, the information indicating the business operator registration stores a value in each of attributes named a business operator number 501, a business operator name 502, an address 503, a registration date 504, a cancellation date 505, and an expiration date 506. Here, in the case where the business operator number of the form issuer in the form information recognized in S402 is "T2023123456789", the values stored in the attributes of registrant information 507 associated with the business operator number are obtained. Moreover, registrant information 508 and 509 may be obtained which includes the business operator numbers similar to that of the form issuer in the form information recognized in S402. In other words, similar registrant information may be obtained which includes the identification information of a registered business operator of which a character string matching degree with the identification information of the form issuer included in the form information is equal to or greater than a predetermined threshold. The predetermined threshold may be set to any value as described above.

In S404, the extraction unit 304 extracts correction candidates for the form information from the business operator registration information obtained in S403. Specifically, candidate values are extracted as correction candidates for the item names "business operator number" and "business operator name". In addition, information indicating a registration status is extracted. In the business operator registration information (registrant information), each of multiple pieces of identification information is associated with a registration period of the registered business operator such as the registration date, the cancellation date, and the expiration date. The extraction unit 304 obtains the information indicating the registration status from the issue date written in the form, and a period from the registration date (registration start date) to the cancellation date or expiration date indicated in the registration period information of the registered business operator.

### CORRECTION CANDIDATES FOR FORM INFORMATION

FIG. 5B is a diagram illustrating an example of correction candidates for the form information. Form information candidates 510 are presented as an example of some of correction candidates for the form information extracted by the extraction unit 304. In the form information candidates 510, each row corresponds to one record of information indicating a correction candidate for correcting the form information. For example, the information indicating a correction candidate for the form information stores a value in each of attributes named an item name 511, a candidate value 512, and a registration status 513. For the attribute named the registration status 513, a value obtained from the registration date, the cancellation date, the expiration date, and a process date is stored.

Here, an example will be described in detail in which the form information recognized in S402 includes "T2022123456789" as the business operator number of the form issuer and "4/15/2024" as the issue date and the business operator registration information 500 is obtained in S403.

First, the business operator number recognized in S402 is added as a candidate 514. Specifically, the attribute values "business operator number" and "T2022123456789" are added as the item name 511 and the candidate value 512, respectively. Moreover, the attribute value "unregistered" is added as the registration status 513 because the business operator number "T2022123456789" is not included in the registrant information obtained in S403.

Next, a row indicating the registrant information 507 in the business operator registration information 500 obtained in S403 is added. Specifically, the attribute values "business operator number" and "T2023123456789" are added as the item name 511 and the candidate value 512, respectively. Moreover, the issue date "4/15/2024" of the form recognized in S402 is compared against the attributes, that is, the registration date 504, the cancellation date 505, and the expiration date 506 of the registrant information 507 in the business operator registration information 500, and the attribute value "registered" is added as the registration status 513, and thus a candidate 515 is added.

Similarly, in the case of adding a row indicating the registrant information 508 in the business operator registration information 500 obtained in S403, the attribute values "business operator number" and "T2022123456788" are added as the item name 511 and the candidate value 512, respectively, and thus a candidate 516 is added. Moreover, the issue date "4/15/2024" of the form recognized in S402 is compared against the attributes, that is, the registration date 504, the cancellation date 505, and the expiration date 506 of the registrant information 508 in the business operator registration information 500, and the attribute value "canceled" is added as the registration status 513.

The above description is given by using the example in which the correction candidates for the form information recognized in S402 are extracted by using the registrant information obtained in S403; however, the extraction is not limited to this. The form information stored in the storage unit 307 may be obtained and the correction candidates for the form information may be extracted from the obtained form information.

### FORM INFORMATION

FIG. 5C is a diagram illustrating an example of form information. Form information 520 is an example of a part of form information stored in the storage unit 307. In the form information 520, each row corresponds to one record of information indicating the form information on which checking and correction are completed. For example, the information indicating the form information stores a value in each of attributes named a business operator number 521 and a business operator name 522 of a business operator as the form issuer, a billing destination 523 of the form, an issue date 524, a product name 525 for each product in the form, and an amount 526.

In the case where the business operator number of the form issuer in the form information recognized in S402 is "T2023123456789", the extraction unit 304 obtains the form information 527 associated with the business operator number. The extraction unit 304 may further obtain the form information including a similar business operator number as in S403. Next, the extraction unit 304 extracts correction candidates using the obtained form information, in the same manner as in the example in which correction candidates for the form information are extracted from the registrant information obtained in S403.

The above description is given by using the example in which the business operator number is extracted as a correction candidate for the form recognition result; however, the correction candidate is not limited to this. For example, business operator information such as the business operator name and address, invoice information such as a total amount and a total tax amount, and detailed information such as a product name, an amount, and a tax rate of each product may be extracted as correction candidates for a form recognition result. Specifically, in the case of the business operator name, the business operator name recognized in S402 is added as a candidate 517. Specifically, the attribute values "business operator name" and "AAA Co., Ltd." are added as the item name 511 and the candidate value 512, respectively. Moreover, since the business operator name "AAA Co., Ltd." is included in the registrant information obtained in S403, the attribute value "registered" may be added as the registration status 513. Instead, form information including a product name written in the form may be obtained in S402 and form information including the product name included in the obtained form information may be obtained from the confirmed form information stored in S404 as a correction candidate for the form recognition result.

In S405, the presentation unit 305 presents to the terminal apparatus 103 the form information recognized in S402 and the correction candidates for the form information extracted in S404.

In S406, the display control unit 311 of the terminal apparatus 103 displays a form information setting screen including the form information and the correction candidates for the form information presented in S405 by the information processing apparatus 101. The form information setting screen is a GUI for presenting to the user the recognized form information and the correction candidates for the form information. To display the form information and the correction candidates for the form information on the terminal apparatus 103 makes it possible to promote the user to check and correct the form information generated from the form.

### Form Information Setting Screen

FIG. 6 is a diagram illustrating an example of a form information setting screen. A form information setting screen 600 includes a form image 601, a recognized business operator number 602, a business operator category 603, a message 604, candidate buttons 605, a button 606, a button 607, a GUI 608, and a confirm button 609.

On the form information setting screen 600, the form image 601 received in S401 and the items in the form information recognized in S402, for example, the recognized business operator number 602 are displayed. In this display, the business operator category 603 may also be displayed in association with the identification information, which is the recognized business operator number, based on the recognized business operator number 602 and the registration status 513 illustrated in FIG. 5B. The business operator category 603 is, for example, a category under tax law related to qualified invoice issuer registration in the qualified invoice system. In the case where the registration status 513 is "Registered", "Qualified" may be displayed to indicate that the business operator is a qualified invoice issuer. In the case where the registration status 513 is "Canceled", "Unregistered", or the like, "Unqualified" or "Ineligible" may be displayed to indicate that the business operator is an unqualified invoice issuer. In the case where the business operator number is not recognized as the form information because the business operator number is not written in the form image or for any other reason, "Exempt" or the like may be displayed to indicate that the business operator is a tax-exempt business operator. Here, the qualified invoice issuer is a taxable business operator for consumption tax registered to be qualified to issue qualified invoices. A buyer-side business operator using the terminal apparatus 103 needs qualified invoices in order to apply input tax credits.

Moreover, for example, the message 604 may be displayed which indicates the reason why the business operator category 603 is determined or the like. Here, character strings to be displayed in the business operator category 603 and the message 604 may be generated by the extraction unit 304 during extraction of correction candidates for the form information in S404.

The candidate buttons 605 are buttons for setting the corrected form information by selecting one of the correction candidates for the form information extracted in S404. In FIG. 6, "T2024123456789 (Qualified)" and "T2022123456788 (Unqualified)" are selectively displayed as the candidates for the business operator number. Each portion different from the form information recognized in S402 may be displayed in an emphasized manner. In addition, a business operator category estimated in the same way as in the foregoing business operator category 603 may be displayed in each of correction candidates for the form information which is the form recognition result. Moreover, the "Form Defect Report" button 606 may be prepared. For example, in the case where the button 606 is pressed by a user operation, an instruction to transmit a message to a sender of the form image received in S401, the message urging the sender to resend the form, may be transmitted to the reception unit 306. Here, the "Manual Correction" button 607 for allowing the user to make manual correction may be displayed to prompt the user to make manual correction. In the case where the button 607 is pressed by a user operation, a GUI to which text or the like can be input may be displayed. The above description is given by using the business operator number as the example of the item in the form information; however, the item is not limited to this. The business operator name, the billing date, the product name, the amount, or the like may be used and the GUI 608 with the same types of contents as the GUI for the business operator number may be displayed. Specifically, a recognized business operator name 611 of the form issuer, candidate buttons 612, a "Form Defect Report" button 613, and a "Manual Correction" button 614 may be displayed. Here, the "Form Defect Report" button 613 and the "Manual Correction" button 614 have the same functions as the "Form Defect Report" button 606 and the "Manual Correction" button 607, respectively, so detailed explanations thereof are omitted. The candidate buttons 612 are buttons for setting the corrected form information by selecting one of the correction candidates for the form information extracted in S404. The display method illustrated in FIG. 6 is just an example, and is not intended to limit the technology of the present disclosure.

In S407, the reception unit 312 in the terminal apparatus 103 receives a confirmation and a correction of the form information by the user regarding the form information displayed in S406. In the case where the user confirms that the information presented in both the recognized business operator number and the recognized business operator name is correct information, the reception unit 312 receives the pressing of the confirm button 609 by the user. In the case where the user confirms that the information presented in any one of the recognized business operator number and the recognized business operator name is incorrect information, the reception unit 312 receives the pressing of the confirm button 609 by the user in a state where any one of the options displayed in the correction candidates is selected by the user.

In S408, the transmission unit 313 in the terminal apparatus 103 transmits to the information processing apparatus 101 the corrected form information confirmed by the user operation received in S407. For example, the confirmed form information, which is the form information confirmed with the user's pressing of the confirm button 609 on the form information setting screen 600, is transmitted to the information processing apparatus 101.

In S409, the reception unit 306 in the information processing apparatus 101 receives the confirmed form information transmitted by the terminal apparatus 103 in S408. The information processing apparatus 101 may also transmit the received confirmed form information to the core system 20.

In S410, the storage unit 307 stores the confirmed form information received in S409. The form information is stored as the form information 520 as illustrated in FIG. 5C. The detailed attributes of the form information 520 are the same as those mentioned in the description of the extraction of the correction candidates for the form information in S404, so explanations thereof are omitted.

As described above, to present the recognition result of the form information and the correction candidates for the form information makes it possible to promote the user to check and correct the form recognition result.

According to the present embodiment, the user's work for correcting an OCR result can be reduced as described above.

Here, with the technology in Japanese Patent Laid-Open No. 2024-55745, in the case where an OCR result includes an incorrect portion, the user is required to correct the incorrect portion by inputting characters one by one by typing or the like. This correction requires the user to consume a long time and may increase the work in the input operation.

According to the present embodiment, it is possible to reduce the burden of the input operation on the user in examining an OCR result.

In the present embodiment, the example is described in which the registrant information indicating the business operator information of the form issuer is obtained from the registrant management system 30; however the technology in the present embodiment is not limited to this. For example, information on product names in a form may be obtained from a system that manages product information.

In addition, in the present embodiment, the example is described in which the form information checked and corrected by the user is stored in the form recognition system and transmitted to the core system; however the technology in the present embodiment is not limited to this. For example, the form information checked and corrected by the user may be either stored in the form recognition system or transmitted to the core system, or a transmission destination may be a general-purpose data storage system to execute general processing not limited to specific processing. In addition, in the present embodiment, the example is described in which the form information checked and corrected by the user is stored or transmitted; however, for example, a file name may be generated by combining some parts of the form information. The generated file name may be given to a file including the scanned image from which the form information is recognized, and then the file may be stored or transmitted.

In the present embodiment, the example is described in which the registration status is added as the attribute of the correction candidate for the form information; however the technology in the present embodiment is not limited to this. For example, as the attribute of the correction candidate for the form information, a similarity indicating a character string matching degree between the correction candidate and the identification information of the form issuer included in the form information or the like may be added. Further, the correction candidates for the form recognition result may be displayed in descending order of the added similarity or may be displayed at highest to lowest degrees of emphasis in descending order of the added similarity. In other words, the identification information of registered business operators, of each of which a character string matching degree with the identification information of the form issuer included in the form information is equal to or greater than a predetermined threshold value may be displayed as correction candidates for the identification information of the form issuer. The predetermined threshold may be set to any value such as a threshold indicating that one character is different among 14 characters, a threshold indicating that two characters are different, and a threshold indicating that three characters are different.

### Other Embodiments

The technology of the present disclosure is described above in detail in the embodiment, but is not limited to this embodiment. The technology of the present disclosure may be applied to embodiments such as a system, an apparatus, a method, a program, and a recording medium (storage medium). Specifically, the technology may be applied to a system including multiple pieces of equipment (such, for example, as a host computer, interface equipment, a receiver, and a Web application) or an apparatus including only one piece of equipment.

Moreover, the object of the technology of the present disclosure may be also achieved in the following manner as a matter of course. Specifically, a recording medium (or a storage medium) that records program codes (a computer program) of software for implementing the functions in the above-described embodiment is provided to a system or an apparatus. Needless to say, the recording medium is a computerreadable recording medium. Then, a computer (or a CPU or MPU) in the system or the apparatus reads and executes the program codes stored in the recording medium. In this case, the program codes read from the recording medium themselves implement the functions in the above-described embodiment and therefore the recording medium that records the program codes is included in the present invention.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the present embodiment, the user's work for correcting an OCR result can be reduced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-186062, filed October 22, 2024, which is hereby incorporated by reference herein in its entirety.

What is claimed is:

1. An information processing apparatus comprising:
at least one memory that stores instructions; and
at least one processor that executes the instructions to:
obtain a scanned image of a form on which a piece of identification information for identifying a form issuer is written;
recognize a plurality of character strings in the scanned image by performing character recognition processing on the scanned image;
inquire of an external system, in which a plurality of pieces of identification information are registered, whether a character string recognized from the piece of identification information among the plurality of character strings recognized is registered in the external system;
display information indicating that the character string is registered in the external system in a case where the character string recognized from the piece of identification information is registered in the external system;
display information indicating that the character string is not registered in the external system in a case where the character string recognized from the piece of identification information is not registered in the external system; and
display a similar character string similar to one character string among the plurality of character strings as a correction candidate for the one character string.

2. The information processing apparatus according to claim 1, wherein
the one character string is the character string recognized from the piece of identification information.

3. The information processing apparatus according to claim 2, wherein
the similar character string is obtained from among the plurality of pieces of identification information registered in the external system.

4. The information processing apparatus according to claim 3, wherein
the similar character string is a character string of which a matching degree with the character string recognized from the piece of identification information is equal to or greater than a predetermined threshold.

5. The information processing apparatus according to claim 1, wherein
in the displaying, the plurality of character strings recognized are displayed.

6. The information processing apparatus according to claim 1, wherein
in the displaying, a character in the similar character string different from the one character string is displayed in an emphasized manner.

7. The information processing apparatus according to claim 1, wherein
in the displaying, the scanned image of the form is displayed.

8. The information processing apparatus according to claim 3, wherein
each of the plurality of pieces of identification information registered is associated with a registration period in the external system,
a character string expressing an issue date written on the form is extracted from among the plurality of character strings recognized,
the registration period associated with the similar character string is extracted from the external system, and
in the displaying, information indicating a registration status of the form issuer obtained from the issue date of the form and the registration period is displayed.

9. The information processing apparatus according to claim 3, wherein
each of the plurality of pieces of identification information registered is associated with a category in the external system,
in the obtaining the similar character string, the category associated with the piece of identification information expressed by the similar character string is extracted from the registrant information, and
in the displaying, the category of the form issuer is displayed.

10. The information processing apparatus according to claim 9, wherein
the category is a category under tax law related to qualified invoice business operator registration.

11. The information processing apparatus according to claim 9, wherein
in the displaying, a reason why the category is generated is displayed.

12. The information processing apparatus according to claim 1, wherein
in the displaying, a button for reporting a defect in the form is displayed.

13. The information processing apparatus according to claim 1, wherein
in the displaying, a button for user's manual correction is displayed.

14. The information processing apparatus according to claim 1, wherein
each of the plurality of pieces of identification information is associated with one of a plurality of business operators in the external system,
a character string expressing an issuer of the form is extracted from the plurality of character strings,
a similar character string similar to the extracted character string of the issuer is obtained from among the plurality of pieces of identification information registered in the registrant information, and
in the displaying, the obtained similar character string of the issuer is displayed as a correction candidate for the extracted character string of the issuer.

15. The information processing apparatus according to claim 1, wherein
the at least processor further executes the instructions to receive a user operation for confirming the plurality of character strings.

16. The information processing apparatus according to claim 15, wherein
the at least processor further executes the instructions to:
store the plurality of character strings confirmed by the user operation; and
in a case where the plurality of character strings are stored, obtain the similar character string from among the plurality of character strings stored and the plurality of pieces of identification information registered in the external system.

17. The information processing apparatus according to claim 16, wherein
a character string expressing a product name written on the form is extracted from the plurality of character strings, and
in a case where the character string expressing the product name is stored while being associated with the character string recognized from the piece of identification information among the plurality of character strings, a similar character string similar to the character string recognized from the piece of identification information associated with the extracted character string expressing the product name is obtained from among the plurality of character strings stored.

18. The information processing apparatus according to claim 1, wherein
in the external system, a business operator identified by the piece of identification information is registered as a qualified invoice issuer.

19. An information processing method comprising:
obtaining a scanned image of a form on which a piece of identification information for identifying a form issuer is written;
recognizing a plurality of character strings in the scanned image by performing character recognition processing on the scanned image;
inquiring of an external system, in which a plurality of pieces of identification information are registered, whether a character string recognized from the piece of identification information among the plurality of character strings recognized is registered in the external system;
displaying information indicating that the character string is registered in the external system in a case where the character string recognized from the piece of identification information is registered in the external system;
displaying information indicating that the character string is not registered in the external system in a case where the character string recognized from the piece of identification information is not registered in the external system; and
displaying a similar character string similar to one character string among the plurality of character strings as a correction candidate for the one character string.

20. A non-transitory computer readable storage medium storing a program for causing a computer to perform an information processing method, the information processing method comprising:
obtaining a scanned image of a form on which a piece of identification information for identifying a form issuer is written;
recognizing a plurality of character strings in the scanned image by performing character recognition processing on the scanned image;
inquiring of an external system, in which a plurality of pieces of identification information are registered, whether a character string recognized from the piece of identification information among the plurality of character strings recognized is registered in the external system;
displaying information indicating that the character string is registered in the external system in a case where the character string recognized from the piece of identification information is registered in the external system;
displaying information indicating that the character string is not registered in the external system in a case where the character string recognized from the piece of identification information is not registered in the external system; and
displaying a similar character string similar to one character string among the plurality of character strings as a correction candidate for the one character string.
